(19) United States
(12) Patent Application Publication
(10) Pub. No.: US 2021/0241763 A1
(43) Pub. Date: Aug. 5, 2021

(54) STORAGE MEDIUM, INFORMATION PROCESSING METHOD, AND INFORMATION PROCESSING APPARATUS

(71) Applicant: FUJITSU LIMITED, Kawasaki-shi (JP)

(72) Inventor: Keigo MOTOSUGI, Nagano (JP)

(73) Assignee: FUJITSU LIMITED, Kawasaki-shi (JP)

(21) Appl. No.: 17/103,823

(22) Filed: Nov. 24, 2020

(30) Foreign Application Priority Data
Jan. 31, 2020 (JP) 2020-014869

(51) Int. Cl. G10L 15/22; G10L 25/27; G06F 3/16; H04R 1/08; H04R 1/02

(52) U.S. Cl. CPC G10L 15/22; G10L 25/27; H04R 1/028; H04R 1/08; G06F 3/16

(57) ABSTRACT

A non-transitory computer-readable storage medium storing a program that causes a computer to execute a process, the process includes identifying, for voice data acquired by a microphone provided in an information processing apparatus, a measurement value of a motion sensor or a geomagnetic sensor of the information processing apparatus at a timing when input of the voice data is accepted; and determining switching of a speaker corresponding to the voice data based on the identified measurement value of the motion sensor or the geomagnetic sensor.

### CROSS-REFERENCE TO RELATED APPLICATION

This application is based upon and claims the benefit of priority of the prior Japanese Patent Application No. 2020-14869, filed on Jan. 31, 2020, the entire contents of which are incorporated herein by reference.

### FIELD

The embodiments discussed herein are related to a storage medium, an information processing method, and an information processing apparatus.

### BACKGROUND

Heretofore, as a speaker identification method in a voice recognition system, there has been a method of identifying a speaker by performing waveform matching between voice data of a speaker registered in advance and recorded voice data. Additionally, there has also been a method of identifying a speaker by using a special microphone equipped with multiple directional microphones, and associating the utterance direction with the speaker.

As a prior art, there has been a spectacle-type display device that extracts at least one of face image data or face feature data of a speaker from image data of a captured field of view, and identifies and extracts a voice signal of the speaker on the basis of at least one of the face image data, the face feature data, or a sound signal of surrounding sound.

For example, Japanese Laid-open Patent Publication No. 2012-59121 and the like are disclosed as related art.

### SUMMARY

According to an aspect of the embodiments, a non-transitory computer-readable storage medium storing a program that causes a computer to execute a process, the process includes identifying, for voice data acquired by a microphone provided in an information processing apparatus, a measurement value of a motion sensor or a geomagnetic sensor of the information processing apparatus at a timing when input of the voice data is accepted; and determining switching of a speaker corresponding to the voice data based on the identified measurement value of the motion sensor or the geomagnetic sensor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an exemplary system configuration of an information processing system 200;

FIG. 3 is a block diagram illustrating an exemplary hardware configuration of an information processing apparatus 101;

FIG. 4 is an explanatory diagram illustrating a screen example of a main screen;

FIG. 5 is an explanatory diagram illustrating a usage example of the information processing apparatus 101;

FIG. 6 is an explanatory diagram illustrating an example of contents stored in a speaker correspondence table (tilt determination) 220a;

FIG. 7 is an explanatory diagram illustrating an example of contents stored in a speaker correspondence table (azimuth determination) 220b;

FIG. 8 is a block diagram illustrating an exemplary functional configuration of the information processing apparatus 101;

FIG. 9 is an explanatory diagram (part 1) illustrating a screen example of a speaker determination setting screen;

FIG. 10 is an explanatory diagram (part 2) illustrating a screen example of the speaker determination setting screen;

FIG. 11 is an explanatory diagram illustrating a setting example of the speaker correspondence table (tilt determination) 220a;

FIG. 12 is an explanatory diagram (part 3) illustrating a screen example of the speaker determination setting screen;

FIG. 13 is an explanatory diagram illustrating a setting example of the speaker correspondence table (azimuth determination) 220b;

FIG. 14 is an explanatory diagram illustrating a screen example of a conversation screen;

FIG. 15 is a flowchart illustrating an example of a voice input processing procedure of the information processing apparatus 101;

FIG. 16 is a flowchart illustrating an example of a sensing data acquisition processing procedure of the information processing apparatus 101; and

FIG. 17 is a flowchart illustrating an example of a speaker identification processing procedure of the information processing apparatus 101.

### DESCRIPTION OF EMBODIMENTS

However, with the prior art, it is difficult to differentiate voice data for each speaker, the voice data being input through a smartphone, a mobile phone, or the like that is not equipped with multiple directional microphones or a special microphone.

In view of the above, it is desirable that voice data can be differentiated for each speaker.

Hereinafter, embodiments of an information processing program, an information processing method, and an information processing apparatus will be described in detail with reference to the drawings.

### Embodiment

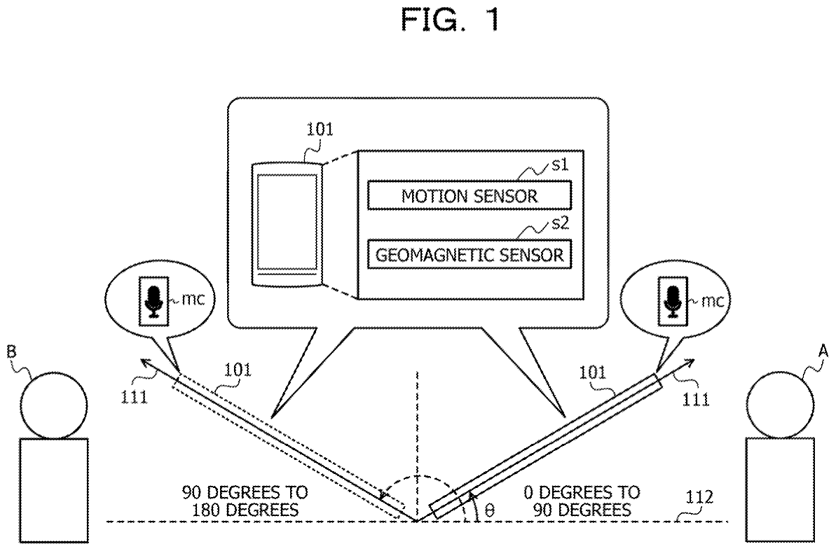

FIG. 1 is an explanatory diagram illustrating an example of an information processing method according to an embodiment. In FIG. 1, an information processing apparatus 101 is a computer that can differentiate, for each speaker, voice data acquired by a microphone mc provided in the information processing apparatus 101. The microphone mc is a device that converts a collected voice into an electric signal.

The microphone mc may be a microphone built in the information processing apparatus 101 or may be an external microphone attachable to the information processing apparatus 101. Voice data may be data in units of fixed intervals, or may be data in units of speech sections, for example.

Here, as a speaker identification method in a voice recognition system, there is a speaker identification method using artificial intelligence (AI). For example, there is a speaker identification method of identifying a speaker by performing waveform matching between voice data of a speaker registered in advance and recorded voice data.

However, this speaker identification method has a problem that the determination accuracy decreases when the speeches of multiple people overlap. Additionally, in the speaker identification method using AI, the amount of calculation tends to increase, which leads to a problem that real-time speaker identification may require hardware such as a high-performance graphics processing unit (GPU).

Additionally, there is a speaker identification method of identifying a speaker by using a special microphone equipped with multiple directional microphones, and associating the utterance direction with the speaker. However, this speaker identification method has a problem that it may require a special device, which is difficult to carry. For example, it is difficult to carry a special device at all times in case of sudden use.

Against this background, in the present embodiment, an information processing method will be described in which a motion sensor s1 or a geomagnetic sensor s2 of the information processing apparatus 101 is used to determine switching of the speaker corresponding to voice data acquired by the microphone mc. Exemplary processing of the information processing apparatus 101 will be described below.

Note, however, that when recording voice using the information processing apparatus 101, the user points the microphone mc provided in the information processing apparatus 101 at the speaker. In the example of FIG. 1, assume that a user A uses the information processing apparatus 101 to interview a user B. In this case, when the user A speaks, the user A points the microphone mc at himself or herself, and when the user B speaks, the user A points the microphone mc at the user B.

(1) The information processing apparatus 101 accepts input of voice data acquired by the microphone mc provided in the information processing apparatus 101. Specifically, the information processing apparatus 101 accepts, through the microphone mc, input of voice data obtained by converting voice collected by the microphone mc into an electronic signal, for example. The voice data is waveform data indicating a temporal change in sound intensity, for example.

(2) The information processing apparatus 101 identifies, for voice data acquired by the microphone mc, the measurement value of the motion sensor s1 or the geomagnetic sensor s2 of the information processing apparatus 101 at the timing when input of the voice data is accepted.

Here, the motion sensor s1 is a device that measures the acceleration, tilt, direction, and the like of an object (information processing apparatus 101). The motion sensor s1 is implemented by combining an acceleration sensor, a gyro sensor, and the like, for example. The geomagnetic sensor s2 is a device that detects geomagnetism to measure the azimuth.

The timing when the input of voice data is accepted is the time point when the input of voice data is accepted by the microphone mc, for example. Additionally, the timing when the input of voice data is accepted may be any time point from the start of the input of voice data to the end thereof (e.g., time point of start of voice input).

Here, assume that an inclination angle θ of the main body of the information processing apparatus 101 is measured as the measurement value of the motion sensor s1. The angle θ is represented by, for example, an angle between an upward axis 111 passing through the center of the main body of the information processing apparatus 101 and a horizontal plane 112. Note, however, that the shape of the information processing apparatus 101 is assumed to be a substantially rectangular plate shape, and the longitudinal direction of a front surface (e.g., screen side) of the information processing apparatus 101 is assumed to be the vertical direction. Additionally, assume that the angle θ when the front surface (or back surface) of the information processing apparatus 101 is parallel to the horizontal plane 112 is zero degrees, and the angle θ increases as the upper end side of the information processing apparatus 101 is raised. Additionally, the microphone mc is provided on the upper end side of the information processing apparatus 101.

(3) The information processing apparatus 101 determines switching of the speaker corresponding to voice data acquired by the microphone mc, on the basis of the identified measurement value of the motion sensor s1 or the geomagnetic sensor s2. Determining switching of the speaker refers to whether or not the person who utters the voice has changed, for example.

Specifically, the information processing apparatus 101 may determine that the speaker has switched in response to the amount of change in the measurement value of the motion sensor s1 or the geomagnetic sensor s2 becoming equal to or greater than a preset threshold value, for example. The amount of change in the measurement value is the amount of change from a measurement value at a timing before the timing when the input of voice data is accepted (e.g., timing when input of previous voice data is accepted, and the like).

Additionally, the information processing apparatus 101 may determine that the speaker has switched in response to the measurement value of the motion sensor s1 or the geomagnetic sensor s2 falling within a preset second range from a preset first range. For example, assume that the measurement value (angle θ) of the motion sensor s1 at the timing when the input of voice data is first accepted is “θ=45 degrees”.

In this case, the information processing apparatus 101 determines that the speaker has not switched when the angle θ is within the range of zero degrees to less than 90 degrees at the timing when the input of voice data is accepted. On the other hand, when the angle θ at the timing when the input of voice data is accepted exceeds the range of zero degrees to less than 90 degrees, the information processing apparatus 101 determines that the speaker has switched.

In the example of FIG. 1, when the angle θ is within the range of zero degrees to less than 90 degrees, it can be determined that the input voice data is voice data corresponding to a speaker (user A). When the angle θ falls within the range of 90 degrees to less than 180 degrees, it can be determined that the speaker has switched, and the input voice data is voice data corresponding to another speaker (user B).

As described above, according to the information processing apparatus 101, it is possible to determine switching of the speaker corresponding to voice data acquired by the microphone mc, and differentiate the voice data for each speaker. For example, it is possible to determine switching of the speaker according to the posture (state) of the information processing apparatus 101 that the user uses or the orientation of the information processing apparatus 101 that the user uses. Additionally, switching of the speaker does not necessarily mean switching among multiple speakers. For example, when the angle θ of the information processing apparatus 101 falls within a different range while one speaker is speaking, it may similarly be determined that the speaker has switched. In this case, it can be considered that the speech of one speaker is punctuated at the timing when it is determined that the speaker has switched.

In the example of FIG. 1, it is possible to determine switching of the speaker from the measurement value (angle θ) of the motion sensor s1 at the timing when the input of voice data acquired by the microphone mc is accepted, and differentiate the voice data for each speaker (user A or user B). Specifically, for example, when it is determined that the speaker has switched, the information processing apparatus 101 outputs the determination result in association with the input voice data. As a result, it is possible to identify the timing and part where the speaker has switched, and differentiate the voice data for each speaker.

(Exemplary System Configuration of Information Processing System 200)

Next, an exemplary system configuration of an information processing system 200 including the information processing apparatus 101 illustrated in FIG. 1 will be described. The information processing system 200 is applied to a service for automatically creating a transcript or minutes from recorded voice, for example.

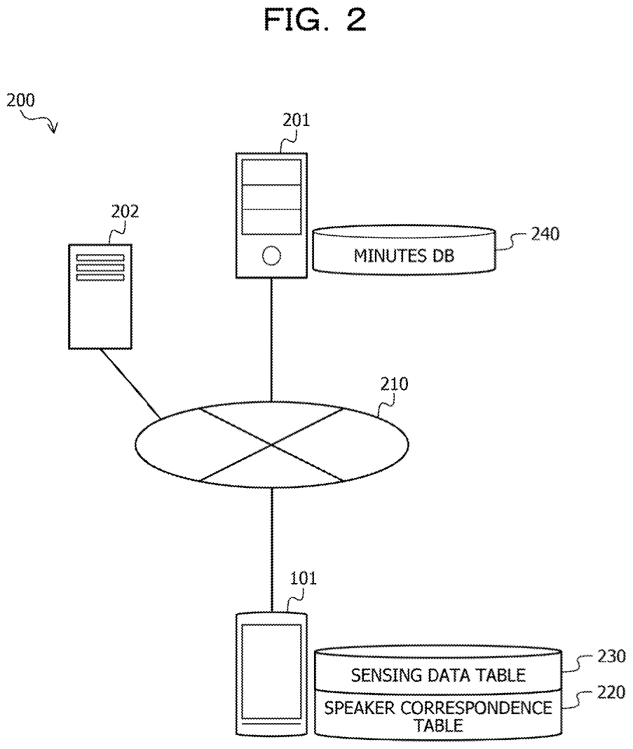

FIG. 2 is an explanatory diagram illustrating an exemplary system configuration of the information processing system 200. In FIG. 2, the information processing system 200 includes the information processing apparatus 101, a minutes server 201, and a voice recognition server 202. In the information processing system 200, the information processing apparatus 101, the minutes server 201, and the voice recognition server 202 are connected through a wired or wireless network 210. Examples of the network 210 include a local area network (LAN), a wide area network (WAN), the Internet, and the like.

Here, the information processing apparatus 101 is a computer used by a user of the information processing system 200. For example, the information processing apparatus 101 is a smartphone, a mobile phone, a tablet terminal, or the like. The information processing apparatus 101 has a speaker correspondence table 220 and a sensing data table 230.

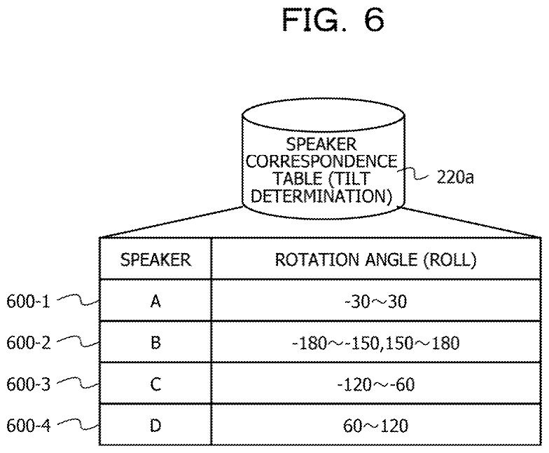

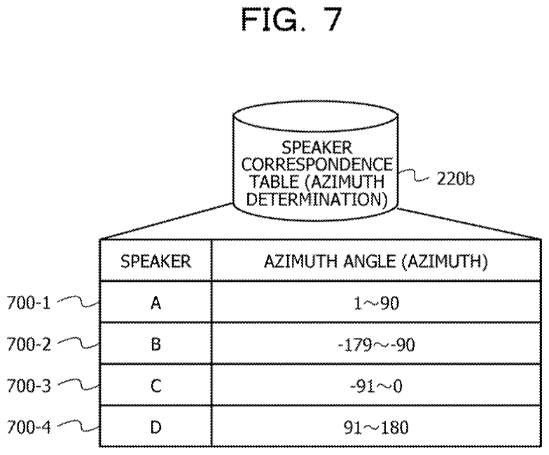

The speaker correspondence table 220 includes a speaker correspondence table (tilt determination) 220a and a speaker correspondence table (azimuth determination) 220b. Note that the stored contents of the speaker correspondence table (tilt determination) 220a and the speaker correspondence table (azimuth determination) 220b will be described later with reference to FIGS. 6 and 7.

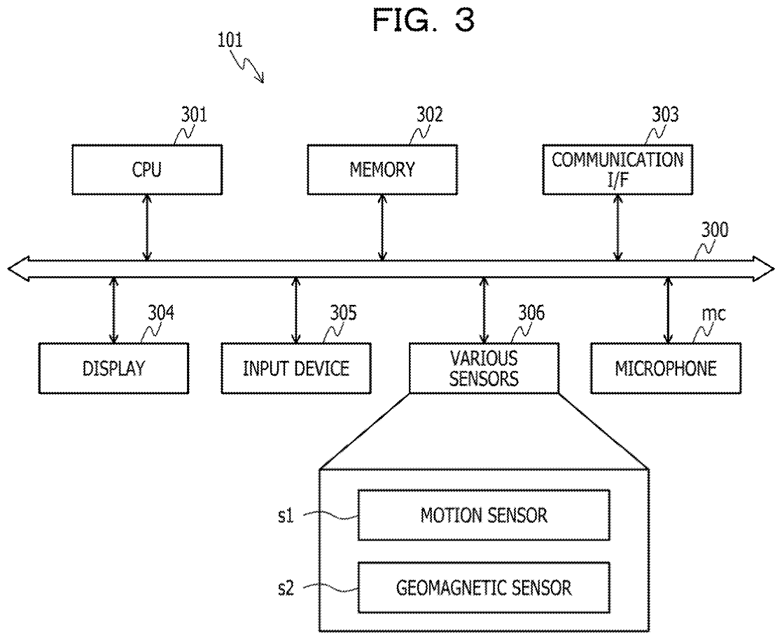

The sensing data table 230 stores sensing data. Sensing data is information that represents the measurement value of various sensors 306 illustrated in FIG. 3 described later in association with information (e.g., measurement time) that identifies a time point when the measurement value was measured.

The minutes server 201 is a computer that has a minutes database (DB) 240 and records the transcript and minutes. The minutes DB 240 stores speech information in association with a minutes identification (ID), for example. A minutes ID is an identifier that uniquely identifies minutes. Speech information includes a speaker name and speech text.

The voice recognition server 202 is a computer that converts voice data into text data. Any existing technology may be used as the technology for converting voice data into text. For example, the voice recognition server 202 recognizes a voice from voice data and converts it into characters (text data) by a method based on machine learning such as deep learning.

Note that while the minutes server 201 and the voice recognition server 202 are implemented by different computers in the example of FIG. 2, the embodiment is not limited to this. For example, the voice recognition server 202 may be implemented by the minutes server 201. Additionally, the information processing system 200 may include multiple information processing apparatuses 101.

In the information processing system 200, the user can use a minutes creation service by connecting to the minutes server 201 from the information processing apparatus 101, for example. A minutes creation service is a service that enables automatic creation of a transcript or minutes from recorded voice, and enables browsing or editing of the automatically created transcript or minutes.

Information (uniform resource locator (URL), authentication token, minutes ID, and the like) for connecting the information processing apparatus 101 to the minutes server 201 can be obtained from a predetermined quick response (QR) code, for example. A predetermined QR code is displayed by a service provider on a personal computer (PC) or the like used by the user, for example. QR code is a registered trademark.

Additionally, when receiving voice data from the information processing apparatus 101, the voice recognition server 202 performs voice recognition processing on the received voice data to convert it into text data, and transmits the converted text data (voice recognition result) to the information processing apparatus 101. A voice recognition result is a recognition result in units of speech sections, for example. A speech section is a section in which voice (speech) is continuously detected.

Note that information (URL, connection key, and the like) for connecting the information processing apparatus 101 to the voice recognition server 202 can be acquired from the minutes server 201, for example.

(Exemplary Hardware Configuration of Information Processing Apparatus 101)

Next, an exemplary hardware configuration of the information processing apparatus 101 will be described with reference to FIG. 3.

FIG. 3 is a block diagram illustrating an exemplary hardware configuration of the information processing apparatus 101. In FIG. 3, the information processing apparatus 101 has a central processing unit (CPU) 301, a memory 302, a communication interface (I/F) 303, a display 304, an input device 305, various sensors 306, and the microphone mc. Additionally, the components are connected to one another through a bus 300.

Here, the CPU 301 performs overall control of the information processing apparatus 101. The CPU 301 may have multiple cores. The memory 302 has a read only memory (ROM), a random access memory (RAM), a flash ROM, and the like, for example. Specifically, the flash ROM stores operating system (OS) programs, the ROM stores application programs, and the RAM is used as a work area for the CPU 301, for example. A program stored in the memory 302 is loaded into the CPU 301 to cause the CPU 301 to execute coded processing.

The communication I/F 303 is connected to the network 210 (see FIG. 2) through a communication line and is connected to an external computer (e.g., minutes server 201, voice recognition server 202) through the network 210. Then, the communication I/F 303 manages an interface between the network 210 and the inside of the information processing apparatus 101, and controls input and output of data from an external device.

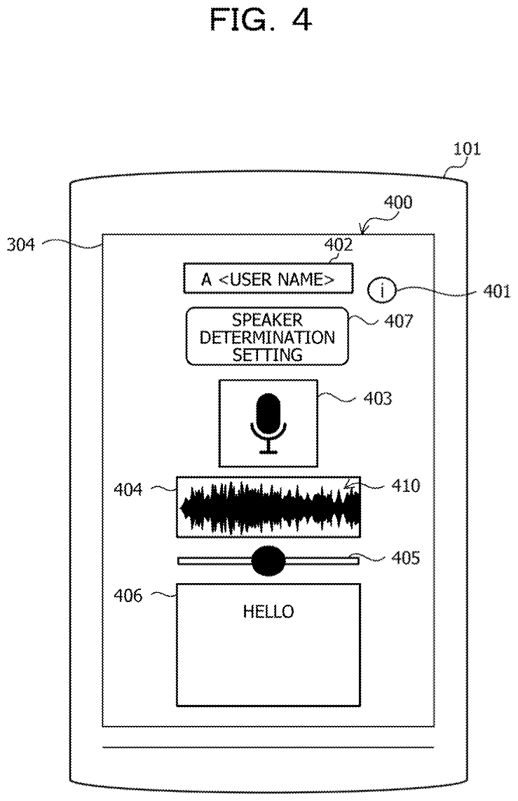

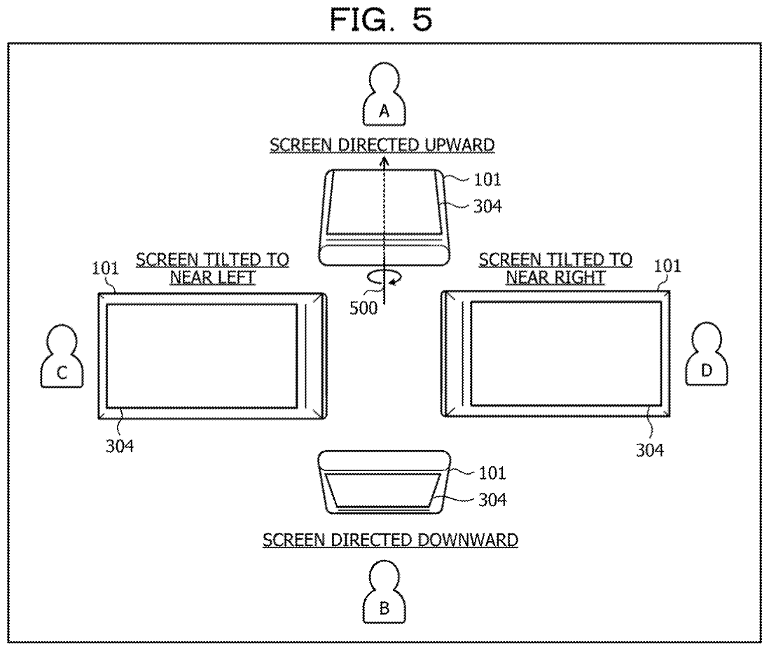

The display 304 is a display device that displays data such as a document, an image, or function information, as well as a cursor and icons or tool boxes. For example, a liquid crystal display, an organic electroluminescence (EL) display, or the like can be adopted as the display 304. The display 304 is provided on a front surface of the information processing apparatus 101, for example, as illustrated in FIGS. 4 and 5 described later.

The input device 305 has keys for inputting characters, numbers, various instructions, and the like, and inputs data. The input device 305 may be a keyboard, a mouse, or the like, or may be a touch-panel input pad, a numeric keypad, or the like.

The various sensors 306 are a group of sensors that measure various information. The various sensors 306 include the motion sensor s1 and the geomagnetic sensor s2, for example. The motion sensor s1 measures the acceleration, tilt, direction, and the like of an object (information processing apparatus 101). The motion sensor s1 is implemented by an acceleration sensor, for example. The geomagnetic sensor s2 detects geomagnetism to measure the azimuth.

The microphone mc is a device that converts a collected voice into an electric signal. The voice collected by the microphone mc is analog/digital (A/D) converted and output as voice data. The microphone mc is a unidirectional microphone, for example. Unidirectionality is a property that makes it easy to capture a sound in a specific direction.

In the following description, as the microphone mc, an external microphone that can be attached (can be connected) to the information processing apparatus 101 will be used as an example.

Note that the information processing apparatus 101 may have a speaker, a disk drive, a disk, a portable recording medium I/F, a portable recording medium, and the like, for example, in addition to the above-described components. Additionally, the various sensors 306 may include a global positioning system (GPS) unit. The GPS unit receives radio waves from a GPS satellite and outputs position information of the information processing apparatus 101. The position information of the information processing apparatus 101 is information such as latitude and longitude that identifies one point on the earth, for example. As the satellite, a satellite of the quasi-zenith satellite system may be used, for example. Additionally, the minutes server 201 and the voice recognition server 202 illustrated in FIG. 2 are implemented by a CPU, a memory, a disk drive, a disk, a communication I/F, a portable recording medium I/F, a portable recording medium, and the like, for example.

(Screen Example of Main Screen)

Next, a screen example of a main screen displayed on the display 304 of the information processing apparatus 101 will be described. The main screen is an operation screen displayed when voice recording is performed, and is displayed when the information processing apparatus 101 connects to the minutes server 201, for example.

FIG. 4 is an explanatory diagram illustrating a screen example of the main screen. In FIG. 4, a main screen 400 includes a connection information display button 401, a speaker display field 402, a recording start button 403, a collected-sound waveform box 404, an adjustment slider 405, a speech display area 406, and a speaker determination setting button 407.

When the connection information display button 401 is selected on the main screen 400 by the user's operation input using the input device 305 illustrated in FIG. 3, a connection information dialog (not illustrated) is displayed. In the connection information dialog, a connection destination URL (minutes server 201), a minutes ID, a minutes name, and the like are displayed, for example.

In the speaker display field 402, a display name of the speaker (speaker name) is displayed. When the speaker display field 402 is selected on the main screen 400, the speaker name can be changed. When the recording start button 403 is selected on the main screen 400, recording can be started. For example, after selecting the recording start button 403, the user conducts an interview or a conference while pointing the microphone mc at the speaker.

Waveform data (e.g., waveform data 410) of the voice currently being collected is displayed in the collected-sound waveform box 404. The adjustment slider 405 is an operation unit for adjusting the sound collection level (sensitivity of microphone mc). The speech display area 406 displays the content of the most recent speech.

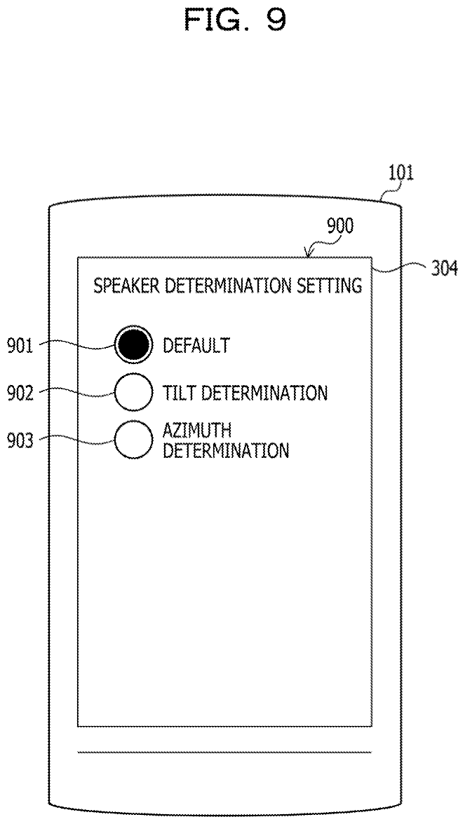

Additionally, when the speaker determination setting button 407 is selected on the main screen 400, a speaker determination setting screen can be displayed. The speaker determination setting screen is an operation screen for making various settings related to speaker determination. A screen example of the speaker determination setting screen will be described later with reference to FIGS. 9, 10 and 12.

(Usage Example of Information Processing Apparatus 101)

Here, a usage example of the information processing apparatus 101 will be described.

FIG. 5 is an explanatory diagram illustrating a usage example of the information processing apparatus 101. Here, assume that the information processing apparatus 101 has a substantially rectangular plate shape and the microphone mc (not illustrated in FIG. 5) is attached to an upper end portion of the information processing apparatus 101. Additionally, assuming that four speakers are identified, the four speakers will be referred to as “speaker A”, “speaker B”, “speaker C”, and “speaker D”. Assume that the user of the information processing apparatus 101 is in the direction of speaker B.

When recording the voice of speaker A, the user holds the information processing apparatus 101, directs the screen of the information processing apparatus 101 upward, and points the microphone mc at speaker A. Directing the screen upward refers to directing the display 304 vertically upward parallel to the horizontal plane. In FIG. 5, an axis 500 is a vertical axis passing through the center of the information processing apparatus 101.

When recording the voice of speaker B, the user moves the wrist holding the information processing apparatus 101 to direct the screen of the information processing apparatus 101 downward, and points the microphone mc at speaker B. At this time, the information processing apparatus 101 is rotated about the axis 500 clockwise or counterclockwise by about 180 degrees by the movement of the user's wrist.

When recording the voice of speaker C, the user moves the wrist holding the information processing apparatus 101 to tilt the screen of the information processing apparatus 101 to the near left, and points the microphone mc at speaker C. Tilting the screen to the near left refers to tilting the upper end portion of the information processing apparatus 101 to the left with the display 304 facing the user. At this time, the information processing apparatus 101 is rotated about the axis 500 about 60 degrees counterclockwise by the movement of the user's wrist.

When recording the voice of speaker D, the user moves the wrist holding the information processing apparatus 101 to tilt the screen of the information processing apparatus 101 to the near right, and points the microphone mc at speaker D. At this time, the information processing apparatus 101 is rotated about the axis 500 clockwise by about 60 degrees by the movement of the user's wrist.

(Contents Stored in Speaker Correspondence Table 220)

Next, contents stored in the speaker correspondence table 220 included in the information processing apparatus 101 will be described with reference to FIGS. 6 and 7. The speaker correspondence table 220 is implemented by the memory 302 illustrated in FIG. 3, for example. Note, however, that the information processing apparatus 101 is assumed to be used as in the usage example illustrated in FIG. 5.

FIG. 6 is an explanatory diagram illustrating an example of contents stored in the speaker correspondence table (tilt determination) 220a. In FIG. 6, the speaker correspondence table (tilt determination) 220a has fields of speaker and rotation angle (roll), and stores records of speaker correspondence information 600-1 to 600-4 by setting information in each field.

Here, a speaker is a speaker whose voice is to be recorded. Note, however, that in FIG. 6, speakers A, B, C, and D are tentative speaker names for differentiating speakers in the information processing apparatus 101, and the names or the like of actual persons do not necessarily have to be set in the initial state. A rotation angle (roll) is one of measurement values measured by the motion sensor s1 of the information processing apparatus 101.

The rotation angle (roll) is an angle when the information processing apparatus 101 is rotated about the reference axis. Note, however, that the reference axis is a vertical axis that passes through the center of the information processing apparatus 101 (e.g., axis 500 illustrated in FIG. 5). Additionally, assume that clockwise is the positive direction and counterclockwise is the negative direction. Additionally, assume that the rotation angle (roll) when the screen of the information processing apparatus 101 is directed upward is “zero degrees”.

For example, the speaker correspondence information 600-1 indicates the range of the rotation angle (roll) corresponding to speaker A “−30 degrees to 30 degrees”. This means that, when the user directs the screen of the information processing apparatus 101 upward and points the microphone mc at speaker A, taking into account some shaking, the rotation angle (roll) is within the range of “−30 degrees to 30 degrees”.

Additionally, for example, the speaker correspondence information 600-4 indicates the range of the rotation angle (roll) corresponding to speaker D “60 degrees to 120 degrees”. This means that, when the user moves the wrist holding the information processing apparatus 101 and points the microphone mc at speaker D, taking into account some shaking, the rotation angle (roll) is within the range of “60 degrees to 120 degrees”.

Note that while the range of the rotation angle (roll) is described here as an example of a range related to the measurement value of the motion sensor s1 to be associated with each speaker, the range is not limited to this. For example, the range of the tilt angle (pitch) representing the tilt of the main body of the information processing apparatus 101 may be used as the range related to the measurement value of the motion sensor s1 to be associated with each speaker. Additionally, a combination of the tilt angle (pitch) and the rotation angle (roll) may be used as the range related to the measurement value of the motion sensor s1 to be associated with each speaker.

The range related to the measurement value of the motion sensor s1 to be associated with each speaker can be set arbitrarily. For example, the setting person sets each range by determining the posture of the information processing apparatus 101 for recording the voice of each speaker, and then checks the measurement value of the motion sensor s1 while changing the posture of the information processing apparatus 101. The setting person is an administrator of the information processing system 200, a user of the information processing apparatus 101, or the like, for example.

FIG. 7 is an explanatory diagram illustrating an example of contents stored in the speaker correspondence table (azimuth determination) 220b. In FIG. 7, the speaker correspondence table (azimuth determination) 220b has fields of speaker and azimuth angle (azimuth), and stores records of speaker correspondence information 700-1 to 700-4 by setting information in each field.

Here, a speaker is a speaker whose voice is to be recorded. An azimuth angle (azimuth) is one of measurement values measured by the geomagnetic sensor s2 of the information processing apparatus 101. An azimuth angle (azimuth) is an angle relative to a reference azimuth. The reference azimuth is a true north direction, for example. Note, however, that clockwise is assumed to be the positive direction and counterclockwise is assumed to be the negative direction.

For example, the speaker correspondence information 700-1 indicates the range of the azimuth angle (azimuth) corresponding to speaker A “one degree to 90 degrees”. This means that, when the user directs the screen of the information processing apparatus 101 upward and points the microphone mc at speaker A, taking into account some shaking, the azimuth angle (azimuth) is within the range of “one degree to 90 degrees”.

(Exemplary Functional Configuration of Information Processing Apparatus 101)

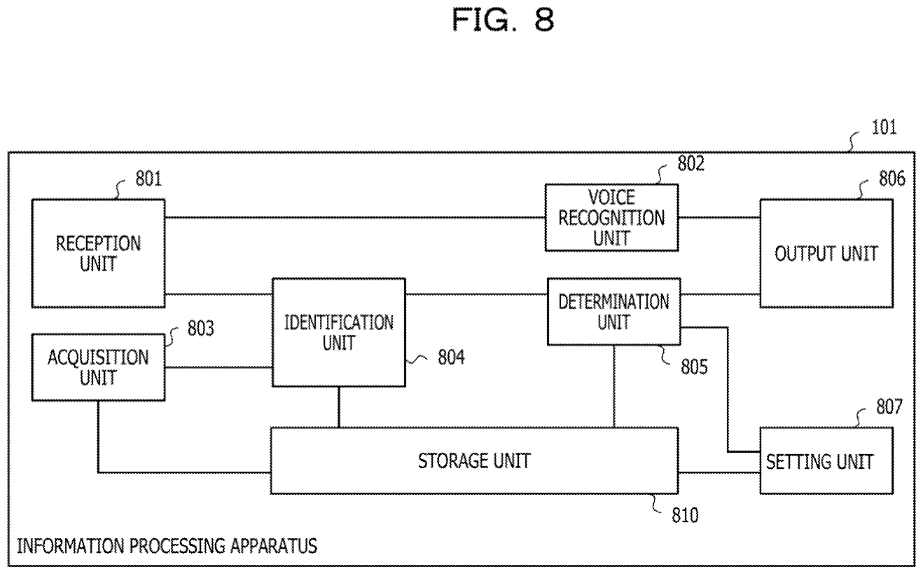

FIG. 8 is a block diagram illustrating an exemplary functional configuration of the information processing apparatus 101. In FIG. 8, the information processing apparatus 101 includes a reception unit 801, a voice recognition unit 802, an acquisition unit 803, an identification unit 804, a determination unit 805, an output unit 806, a setting unit 807, and a storage unit 810. Specifically, for example, the reception unit 801 to the setting unit 807 achieve the functions by causing the CPU 301 to execute programs stored in a storage device such as the memory 302 illustrated in FIG. 3, or a disk or a portable recording medium not illustrated, or through the communication I/F 303. The processing result of each functional unit is stored in the memory 302, for example. Additionally, the storage unit 810 is implemented by the memory 302, for example. Specifically, for example, the storage unit 810 stores the speaker correspondence table 220 and the sensing data table 230 illustrated in FIG. 2.

The reception unit 801 accepts input of voice data acquired by the microphone mc provided in the information processing apparatus 101. Specifically, for example, the reception unit 801 accepts, through the microphone mc, input of voice data obtained by converting voice collected by the microphone mc into an electronic signal. The input voice data is buffered in the memory 302, for example. The data to be buffered (buffer data) is voice data in units of one second, for example.

The voice recognition unit 802 acquires a voice recognition result obtained by performing voice recognition processing on the input voice data. A voice recognition result is text data indicating the content of speech of a speaker corresponding to the voice data, for example. Specifically, for example, the voice recognition unit 802 transmits the input voice data (e.g., buffer data) to the voice recognition server 202 illustrated in FIG. 2.

Voice data includes information (time information and the like) that identifies a time point when the voice data is input, for example. Then, the voice recognition unit 802 receives the voice recognition result from the voice recognition server 202 to acquire the voice recognition result obtained by performing voice recognition processing on the input voice data. Note, however, that voice recognition processing may be performed in the information processing apparatus 101.

The acquisition unit 803 acquires measurement values of various sensors 306. Specifically, for example, the acquisition unit 803 acquires the measurement value of the motion sensor s1 of the information processing apparatus 101 at fixed intervals or every time the measurement value changes. Additionally, the acquisition unit 803 acquires the measurement value of the geomagnetic sensor s2 of the information processing apparatus 101 at fixed intervals or every time the measurement value changes. The fixed interval is about 10 milliseconds, for example.

The acquired measurement value of the motion sensor s1 and measurement value of the geomagnetic sensor s2 are stored in the sensing data table 230 in association with the measurement time of each measurement value, for example.

The identification unit 804 identifies the measurement value of the motion sensor s1 or the geomagnetic sensor s2 of the information processing apparatus 101 at the timing when the input of voice data is accepted. The measurement value of the motion sensor s1 is a rotation angle (roll) measured by the motion sensor s1 (acceleration sensor) built in the information processing apparatus 101, for example. The measurement value of the geomagnetic sensor s2 is an azimuth angle (azimuth) measured by the geomagnetic sensor s2 built in the information processing apparatus 101, for example.

Specifically, for example, the identification unit 804 first identifies the timing when the input of voice data is accepted. The timing when the input of voice data is accepted is a time point when the input of voice data is started, for example. For example, in a case where voice data is data in units of speech sections, the timing when the input of voice data is accepted corresponds to a timing when the speech is started.

Next, the identification unit 804 refers to the sensing data table 230 to identify the measurement value of the motion sensor s1 or the geomagnetic sensor s2 at the identified timing. An identified measurement value is a measurement value associated with a measurement time that matches or is closest to the timing when the input of voice data is accepted, for example.

The determination unit 805 determines switching of the speaker corresponding to the input voice data on the basis of the identified measurement value of the motion sensor s1 or the geomagnetic sensor s2. Specifically, for example, the determination unit 805 determines switching of the speaker corresponding to the voice data acquired by the microphone mc, in response to the measurement value of the motion sensor s1 or the geomagnetic sensor s2 falling within the preset second range from the preset first range.

Additionally, the determination unit 805 refers to the storage unit 810, and identifies the speaker corresponding to the range including the identified measurement value of the motion sensor s1 or the geomagnetic sensor s2 as the speaker corresponding to the input voice data. Here, the storage unit 810 stores the range related to the measurement value of the motion sensor s1 or the geomagnetic sensor s2 in association with information for identifying the speaker.

Specifically, for example, the determination unit 805 refers to the speaker correspondence table (tilt determination) 220a and identifies the speaker corresponding to the range including the identified measurement value of the motion sensor s1. Additionally, the determination unit 805 refers to the speaker correspondence table (azimuth determination) 220b and identifies the speaker corresponding to the range including the identified measurement value of the geomagnetic sensor s2.

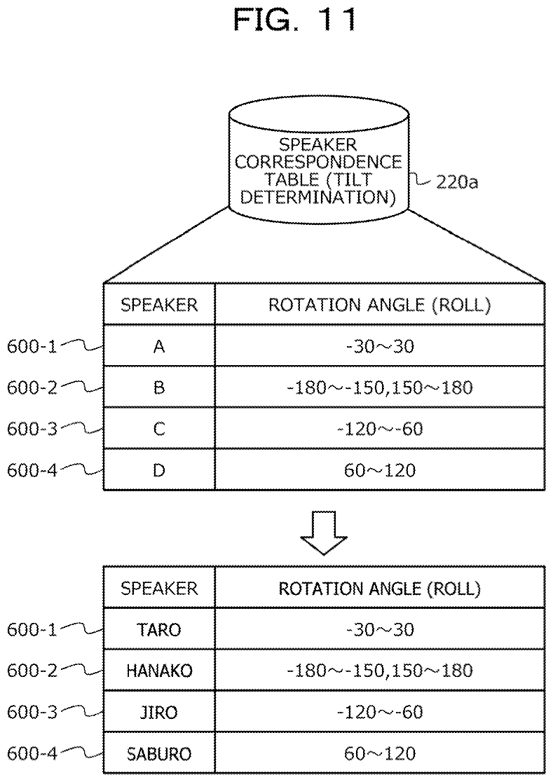

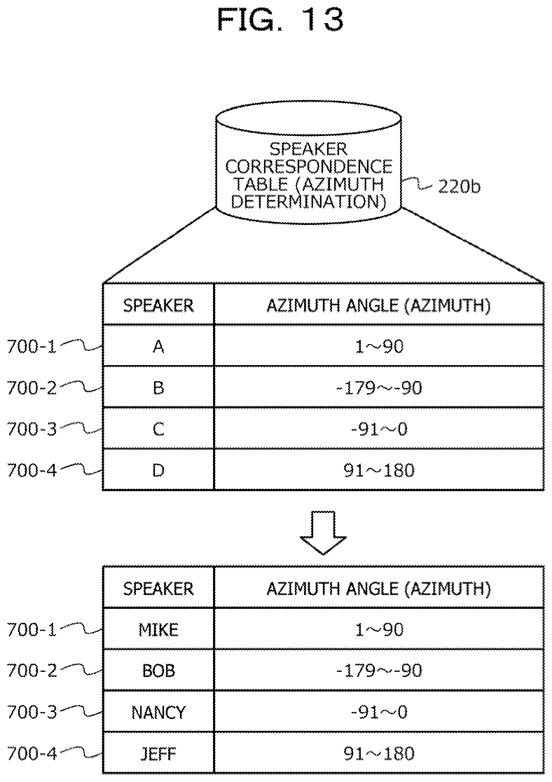

An example of identification of the speaker will be described later with reference to FIGS. 11 and 13. Note that if a range including the identified measurement value of the motion sensor s1 or the geomagnetic sensor s2 does not exist, the determination unit 805 may identify the same speaker as the speaker identified immediately before. At this time, if a speaker identified immediately before does not exist, the determination unit 805 may identify a specific speaker set in advance.

The output unit 806 outputs, in association with the identified speaker, a recognition result obtained by performing voice recognition processing on the input voice data. Examples of the scheme of output by the output unit 806 include storage in the memory 302, transmission to another computer (e.g., minutes server 201 illustrated in FIG. 2) by the communication I/F 303, display on the display 304, print output to a printer not illustrated, and the like.

Specifically, for example, the output unit 806 may display the acquired voice recognition result on the main screen 400 illustrated in FIG. 4, in association with information (speaker name and the like) for identifying the identified speaker. For example, information (speaker name and the like) for identifying the speaker is displayed in the speaker display field 402, and the voice recognition result is displayed in the speech display area 406.

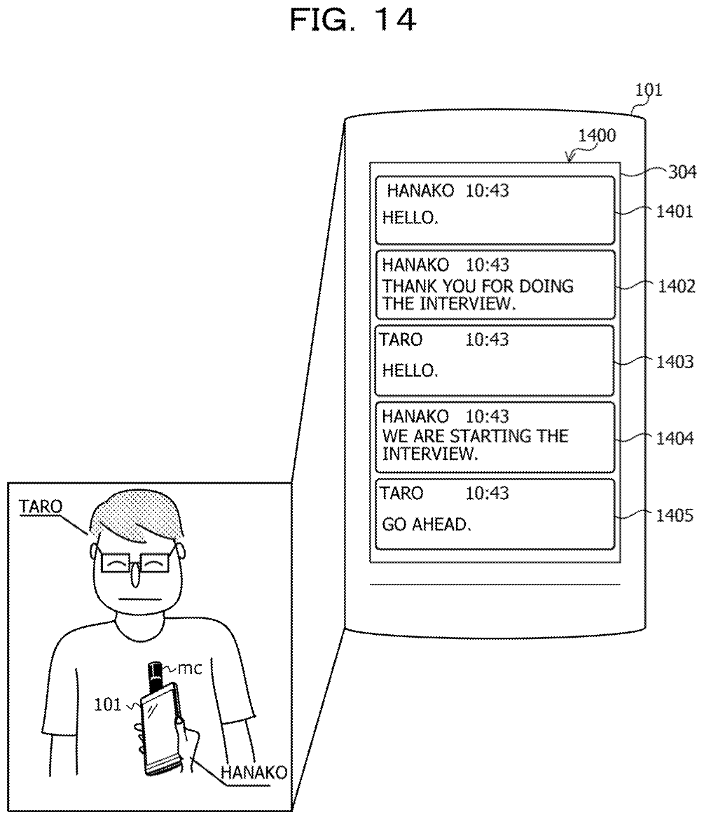

Additionally, the output unit 806 may display the acquired voice recognition result on a conversation screen, in association with the information (speaker name and the like) for identifying the identified speaker. A conversation screen is a screen for displaying a conversation of speakers whose voices have been recorded. A screen example of the conversation screen will be described later with reference to FIG. 14.

Additionally, the output unit 806 may transmit speech information including the information (speaker name and the like) for identifying the identified speaker and the acquired voice recognition result (speech text) to the minutes server 201. Speech information may include a minutes ID, for example. A minutes ID can be obtained from a QR code that records information for connecting to the minutes server 201, for example.

The minutes server 201 creates minutes on the basis of the received speech information. More specifically, for example, the minutes server 201 creates minutes recording a transcript including a speaker name and speech text, in association with a minutes ID. The created minutes are registered in the minutes DB 240, for example.

Additionally, the output unit 806 may output the determination result of speaker switching in association with the input voice data (or voice recognition result obtained by performing voice recognition processing on voice data). Specifically, for example, when it is determined that the speaker has switched, the output unit 806 outputs the determination result in association with the input voice data.

The setting unit 807 accepts designation of a speaker corresponding to the range related to the measurement value of the motion sensor s1 or the geomagnetic sensor s2 of the information processing apparatus 101. Then, the setting unit 807 stores information for identifying the designated speaker in the storage unit 810 in association with the range related to the measurement value of the motion sensor s1 or the geomagnetic sensor s2.

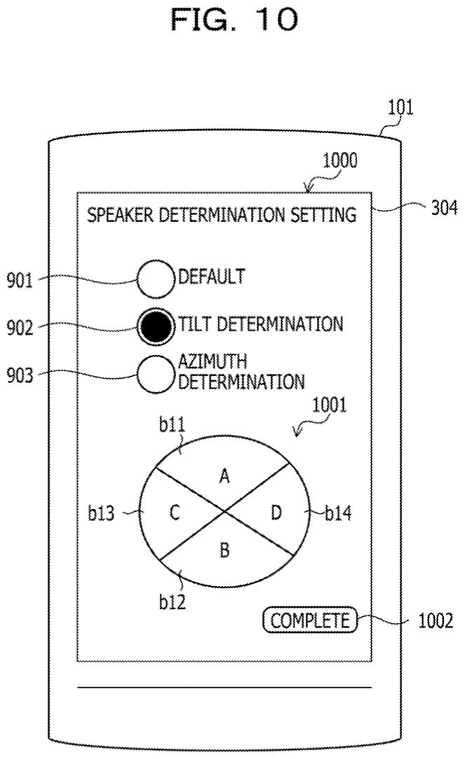

Specifically, for example, the setting unit 807 accepts, for each range related to the measurement value of the motion sensor s1, designation of a speaker corresponding to the range. A speaker corresponding to each range related to the measurement value of the motion sensor s1 is designated on a speaker determination setting screen 1000 as illustrated in FIG. 10 described later, for example.

Then, the setting unit 807 stores information for identifying the designated speaker (e.g., speaker name) in the speaker correspondence table (tilt determination) 220a, for each range related to the measurement value of the motion sensor s1, in association with the range. A setting example of the speaker correspondence table (tilt determination) 220a will be described later with reference to FIG. 11. Note that the information for identifying the speaker does not necessarily have to be set for all rotation angles in the speaker correspondence table (tilt determination) 220a.

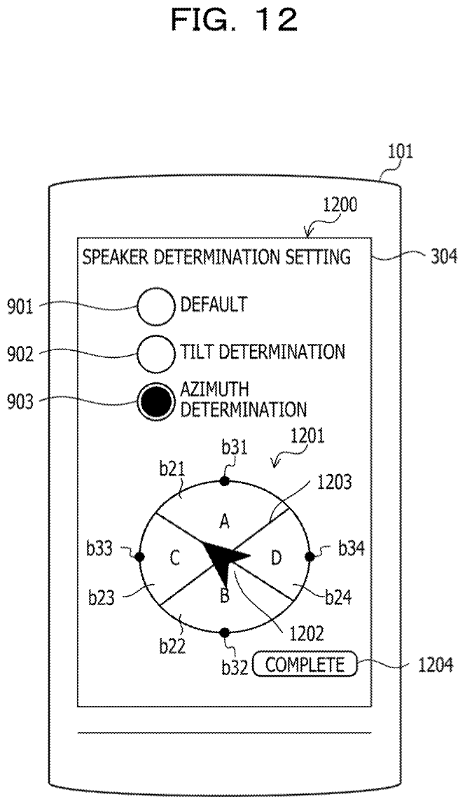

Additionally, the setting unit 807 accepts, for each range related to the measurement value of the geomagnetic sensor s2, designation of a speaker corresponding to the range. A speaker corresponding to each range related to the measurement value of the geomagnetic sensor s2 is designated on the speaker determination setting screen 1200 as illustrated in FIG. 12 described later, for example.

Then, the setting unit 807, stores information for identifying the designated speaker (e.g., speaker name) in the speaker correspondence table (azimuth determination) 220b, for each range related to the measurement value of the geomagnetic sensor s2, in association with the range. A setting example of the speaker correspondence table (azimuth determination) 220b will be described later with reference to FIG. 13. Note that the information for identifying the speaker does not necessarily have to be set for all azimuth angles in the speaker correspondence table (azimuth determination) 220b.

Additionally, the setting unit 807 may be configured to accept selection of any one of a first determination method using the motion sensor s1 and a second determination method using the geomagnetic sensor s2. Specifically, for example, the setting unit 807 accepts selection of the determination method by the user's operation input using the input device 305 illustrated in FIG. 3. The determination method is selected on a speaker determination setting screen 900 as illustrated in FIG. 9 described later, for example.

Additionally, the determination unit 805 may be configured to determine switching of the speaker on the basis of the measurement value of the motion sensor s1 or the geomagnetic sensor s2 according to the selected determination method. Additionally, the determination unit 805 may be configured to identify the speaker corresponding to the range including the measurement value of the motion sensor s1 or the geomagnetic sensor s2 according to the selected determination method.

Specifically, for example, in a case where the first determination method is selected, the determination unit 805 refers to the speaker correspondence table (tilt determination) 220a, and identifies the speaker corresponding to the range including the identified measurement value of the motion sensor s1. Alternatively, in a case where the second determination method is selected, the determination unit 805 refers to the speaker correspondence table (azimuth determination) 220b, and identifies the speaker corresponding to the range including the identified measurement value of the geomagnetic sensor s2. In a case where the speaker is not set in the speaker correspondence table (azimuth determination) 220b, the determination unit 805 may determine that the voice data is being switched at that point.

Note that each functional unit of the information processing apparatus 101 described above may be implemented by multiple computers (e.g., information processing apparatus 101 and minutes server 201) in the information processing system 200. Alternatively, each functional unit of the information processing apparatus 101 described above may be implemented by another computer (e.g., minutes server 201) in the information processing system 200.

(Screen Example of Speaker Determination Setting Screen)

Next, a screen example of the speaker determination setting screen displayed on the display 304 of the information processing apparatus 101 will be described.

FIG. 9 is an explanatory diagram (part 1) illustrating a screen example of the speaker determination setting screen. In FIG. 9, the speaker determination setting screen 900 is an example of an operation screen for accepting selection of a determination method for determining a speaker corresponding to voice data acquired by the microphone mc.

According to the speaker determination setting screen 900, the user can arbitrarily select the determination method for determining the speaker depending on the use case. For example, on the speaker determination setting screen 900, when a check box 902 is selected by the user's operation input using the input device 305, tilt determination using the motion sensor s1 (first determination method) can be selected.

Alternatively, when a check box 903 is selected on the speaker determination setting screen 900, azimuth determination using the geomagnetic sensor s2 (second determination method) can be selected. Note that when a check box 901 is selected on the speaker determination setting screen 900, a default determination method can be selected.

The default determination method is a method of determining the speaker set in the speaker display field 402 of the main screen 400 (see FIG. 4) as the speaker corresponding to voice data acquired by the microphone mc. When the default determination method is selected, the determination unit 805 identifies the speaker having the speaker name set in the speaker display field 402 as the speaker corresponding to the input voice data.

When the check box 902 is selected on the speaker determination setting screen 900, a speaker determination setting screen 1000 as illustrated in FIG. 10 is displayed on the display 304.

FIG. 10 is an explanatory diagram (part 2) illustrating a screen example of the speaker determination setting screen. In FIG. 10, the speaker determination setting screen 1000 is an example of an operation screen that accepts designation of the speaker corresponding to each range related to the measurement value of the motion sensor s1. Note, however, that the information processing apparatus 101 is assumed to be used as in the usage example illustrated in FIG. 5.

An operation panel 1001 is a circular operation unit including buttons b11 to b14. The buttons b11 to b14 each indicate the relative positional relationship among the speakers “speaker A”, “speaker B”, “speaker C”, and “speaker D” illustrated in FIG. 5. For example, when the user of the information processing apparatus 101 is assumed to be “speaker B”, “speaker A” corresponds to the person located at the front. Additionally, “speaker C” corresponds to the person located on the left side. Additionally, “speaker D” corresponds to the person located on the right side.

When the button b11 is selected on the speaker determination setting screen 1000, speaker A can be designated. More specifically, for example, when the button b11 is selected, a speaker name setting screen (not illustrated) is displayed, and the speaker name of speaker A can be designated.

When the button b12 is selected on the speaker determination setting screen 1000, speaker B can be designated. When the button b13 is selected on the speaker determination setting screen 1000, speaker C can be designated. When the button b14 is selected on the speaker determination setting screen 1000, speaker D can be designated.

According to the speaker determination setting screen 1000, the user can designate the speaker corresponding to each range related to the measurement value of the motion sensor s1, while considering the relative positional relationship between the user (e.g., speaker B) and another speaker.

When a completion button 1002 is selected on the speaker determination setting screen 1000, the designation of the speaker corresponding to each range related to the measurement value of the motion sensor s1 can be completed. As a result, the setting unit 807 sets information for identifying the designated speaker (e.g., speaker name) in the speaker correspondence table (tilt determination) 220a for each range related to the measurement value of the motion sensor s1.

FIG. 11 is an explanatory diagram illustrating a setting example of the speaker correspondence table (tilt determination) 220a. In FIG. 11, as a result of a speaker with a speaker name “Taro” being designated as speaker A, “Taro” is set in the speaker field of the speaker correspondence information 600-1 and the rotation angle (roll) “−30 to 30” is associated therewith. Accordingly, when the rotation angle (roll) measured by the motion sensor s1 is “−30 degrees to 30 degrees”, the speaker is identified as “Taro”.

Additionally, as a result of a speaker with a speaker name “Hanako” being designated as speaker B, “Hanako” is set in the speaker field of the speaker correspondence information 600-2 and the rotation angle (roll) “−180 to −150, 150 to 180” is associated therewith. Accordingly, when the rotation angle (roll) measured by the motion sensor s1 is “−180 degrees to −150 degrees” or “150 degrees to 180 degrees”, the speaker is identified as “Hanako”.

Additionally, as a result of a speaker with a speaker name “Jiro” being designated as speaker C, “Jiro” is set in the speaker field of the speaker correspondence information 600-3 and the rotation angle (roll) “−120 to −60” is associated therewith. Accordingly, when the rotation angle (roll) measured by the motion sensor s1 is “−120 degrees to −60 degrees”, the speaker is identified as “Jiro”.

Additionally, as a result of a speaker with a speaker name “Saburo” being designated as speaker D, “Saburo” is set in the speaker field of the speaker correspondence information 600-4 and the rotation angle (roll) “60 to 120” is associated therewith. Accordingly, when the rotation angle (roll) measured by the motion sensor s1 is “60 degrees to 120 degrees”, the speaker is identified as “Saburo”.

Additionally, when the check box 903 is selected on the speaker determination setting screen 900 illustrated in FIG. 9, the speaker determination setting screen 1200 as illustrated in FIG. 12 is displayed on the display 304.

FIG. 12 is an explanatory diagram (part 3) illustrating a screen example of the speaker determination setting screen. In FIG. 12, a speaker determination setting screen 1200 is an example of an operation screen that accepts designation of the speaker corresponding to each range related to the measurement value of the geomagnetic sensor s2. Note, however, that the information processing apparatus 101 is assumed to be used as in the usage example illustrated in FIG. 5.

An operation panel 1201 is a circular operation unit including buttons b21 to b24. The buttons b21 to b24 indicate the relative positional relationship among the speakers “speaker A”, “speaker B”, “speaker C”, and “speaker D” illustrated in FIG. 5. An arrow 1202 indicates the true north direction. Note that the display on the operation panel 1201 changes in association with the azimuth of the information processing apparatus 101.

For example, when the user of the information processing apparatus 101 is assumed to be “speaker B”, “speaker A” corresponds to the person located at the front. Additionally, “speaker C” corresponds to the person located on the left side. Additionally, “speaker D” corresponds to the person located on the right side.

When the button b21 is selected on the speaker determination setting screen 1200, speaker A can be designated. More specifically, for example, when the button b21 is selected, a speaker name setting screen (not illustrated) is displayed, and the speaker name of speaker A can be designated.

When the button b22 is selected on the speaker determination setting screen 1200, speaker B can be designated. When the button b23 is selected on the speaker determination setting screen 1200, speaker C can be designated. When the button b24 is selected on the speaker determination setting screen 1200, speaker D can be designated.

According to the speaker determination setting screen 1200, the user can designate the speaker corresponding to each range related to the measurement value of the geomagnetic sensor s2, while considering the relative positional relationship between the user (e.g., speaker B) and another speaker and the direction (azimuth).

Additionally, when split buttons b31 to b34 are selected on the speaker determination setting screen 1200, dividing lines (e.g., 1203) can be added to subdivide the range related to the measurement value of the geomagnetic sensor s2. Additionally, when a dividing line (e.g., 1203) is selected and moved on the speaker determination setting screen 1200, the size of each of the buttons b21 to b24 can be changed to vary the range related to the measurement value of the geomagnetic sensor s2 corresponding to each speaker.

Additionally, when a completion button 1204 is selected on the speaker determination setting screen 1200, the designation of the speaker corresponding to each range related to the measurement value of the geomagnetic sensor s2 can be completed. As a result, the setting unit 807 sets information for identifying the designated speaker (e.g., speaker name) in the speaker correspondence table (azimuth determination) 220b for each range related to the measurement value of the geomagnetic sensor s2.

FIG. 13 is an explanatory diagram illustrating a setting example of the speaker correspondence table (azimuth determination) 220b. In FIG. 13, as a result of a speaker with a speaker name “Mike” being designated as speaker A, “Mike” is set in the speaker field of the speaker correspondence information 700-1 and the azimuth angle (azimuth) “1 to 90” is associated therewith. Accordingly, when the azimuth angle (azimuth) measured by the geomagnetic sensor s2 is “1 degree to 90 degrees”, the speaker is identified as “Mike”.

Additionally, as a result of a speaker with a speaker name “Bob” being designated as speaker B, “Bob” is set in the speaker field of the speaker correspondence information 700-2 and the azimuth angle (azimuth) “−179 to −90” is associated therewith. Accordingly, when the azimuth angle (azimuth) measured by the geomagnetic sensor s2 is “−179 degrees to −90 degrees”, the speaker is identified as “Bob”.

Additionally, as a result of a speaker with a speaker name “Nancy” being designated as speaker C, “Nancy” is set in the speaker field of the speaker correspondence information 700-3 and the azimuth angle (azimuth) “−91 to zero” is associated therewith. Accordingly, when the azimuth angle (azimuth) measured by the geomagnetic sensor s2 is “−91 degrees to zero degrees”, the speaker is identified as “Nancy”.

Additionally, as a result of a speaker with a speaker name “Jeff” being designated as speaker D, “Jeff” is set in the speaker field of the speaker correspondence information 700-4 and the azimuth angle (azimuth) “91 to 180” is associated therewith. Accordingly, when the azimuth angle (azimuth) measured by the geomagnetic sensor s2 is “91 degrees to 180 degrees”, the speaker is identified as “Jeff”.

(Screen Example of Conversation Screen)

Next, a screen example of a conversation screen displayed on the display 304 of the information processing apparatus 101 will be described with reference to FIG. 14.

FIG. 14 is an explanatory diagram illustrating a screen example of the conversation screen. In FIG. 14, a conversation screen 1400 is a screen for displaying, in time series, a conversation of speakers whose voices have been recorded. Here, messages 1401 to 1405 indicating the speech content recorded when speaker “Hanako” interviewed speaker “Taro” are displayed.

The conversation screen 1400 is generated on the basis of speech information of the same minutes ID. For example, message 1401 includes the speaker name “Hanako”, the speech time “10:43”, and the speech content “Hello”. The speaker name “Hanako” indicates the speaker identified according to the measurement value of the motion sensor s1 or the geomagnetic sensor s2 at the timing (speech time) when input of voice data corresponding to the speech content “Hello” was accepted.

The conversation screen 1400 allows the user to check the speech content of each speaker recorded when speaker “Hanako” interviewed speaker “Taro”. Note that the conversation screen 1400 is displayed on the display 304 when the information processing apparatus 101 accesses the minutes server 201 and designates a minutes ID, for example. Additionally, the conversation screen 1400 may be displayed on the display 304 in real time during voice recording.

(Various Information Processing Procedures of Information Processing Apparatus 101)

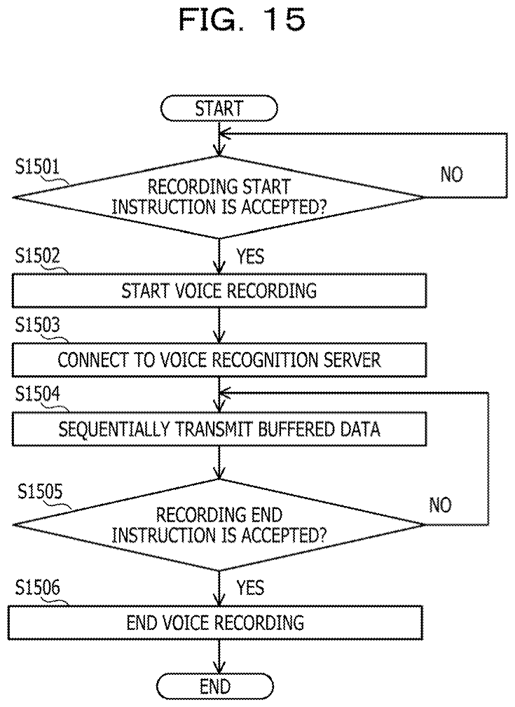

Next, various information processing procedures of the information processing apparatus 101 will be described with reference to FIGS. 15 to 17. First, a voice input processing procedure of the information processing apparatus 101 will be described with reference to FIG. 15.

FIG. 15 is a flowchart illustrating an example of the voice input processing procedure of the information processing apparatus 101. In the flowchart of FIG. 15, first, the information processing apparatus 101 determines whether or not a recording start instruction is accepted (step S1501). A recording start instruction is input in response to selection of the recording start button 403 on the main screen 400 illustrated in FIG. 4, for example.

Here, the information processing apparatus 101 waits for acceptance of the recording start instruction (step S1501: No). Then, if the recording start instruction is accepted (step S1501: Yes), the information processing apparatus 101 starts voice recording (step S1502). As a result, voice data acquired by the microphone mc is buffered.

Next, the information processing apparatus 101 connects to the voice recognition server 202 (step S1503). Then, the information processing apparatus 101 sequentially transmits the buffered data (buffer data) to the voice recognition server 202 (step S1504).

Next, the information processing apparatus 101 determines whether or not a recording end instruction is accepted (step S1505). A recording end instruction is input in response to reselection of the recording start button 403 on the main screen 400 after the voice recording is started by selecting the recording start button 403, for example.

Here, if the recording end instruction is not accepted (step S1505: No), the information processing apparatus 101 returns to step S1504. On the other hand, if the recording end instruction is accepted (step S1505: Yes), the information processing apparatus 101 ends the voice recording (step S1506) and ends the series of processes according to this flowchart.

As a result, the voice data acquired by the microphone mc can be transferred to the voice recognition server 202 and a voice recognition processing can be requested. Note that when voice recording is ended, connection with the voice recognition server 202 is interrupted.

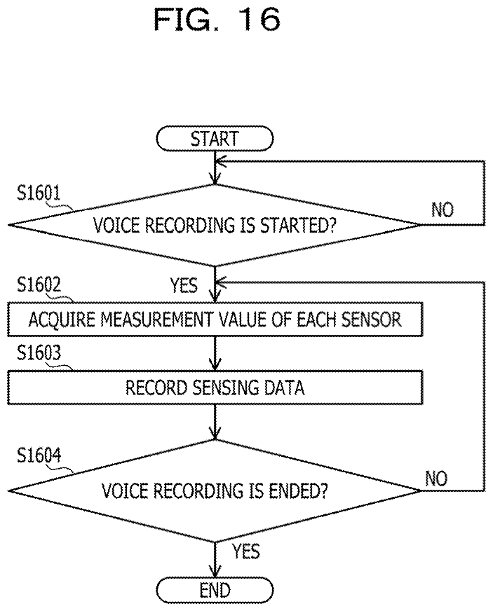

Next, a sensing data acquisition processing procedure of the information processing apparatus 101 will be described with reference to FIG. 16.

FIG. 16 is a flowchart illustrating an example of the sensing data acquisition processing procedure of the information processing apparatus 101. In the flowchart of FIG. 16, first, the information processing apparatus 101 determines whether or not voice recording is started (step S1601). Here, the information processing apparatus 101 waits for the start of voice recording (step S1601: No).

Then, if voice recording is started (step S1601: Yes), the information processing apparatus 101 accesses each of sensors s1 and s2 (motion sensor s1, geomagnetic sensor s2) and acquires the measurement value of each of the sensors s1 and s2 (step S1602).

Next, the information processing apparatus 101 records, in the sensing data table 230, sensing data that represents the acquired measurement values of the sensors s1 and s2 in association with measurement times of the measurement values of the sensors s1 and s2 (step S1603). Then, the information processing apparatus 101 determines whether or not the voice recording is ended (step S1604).

Here, if the voice recording is not ended (step S1604: No), the information processing apparatus 101 returns to step S1602. At this time, the information processing apparatus 101 waits for a fixed time (e.g., 10 milliseconds), for example, and then returns to step S1602. On the other hand, if the voice recording is ended (step S1604: Yes), the information processing apparatus 101 ends the series of processes according to this flowchart.

As a result, the measurement values of the motion sensor s1 and the geomagnetic sensor s2 can be acquired at fixed intervals from the start to the end of voice recording.

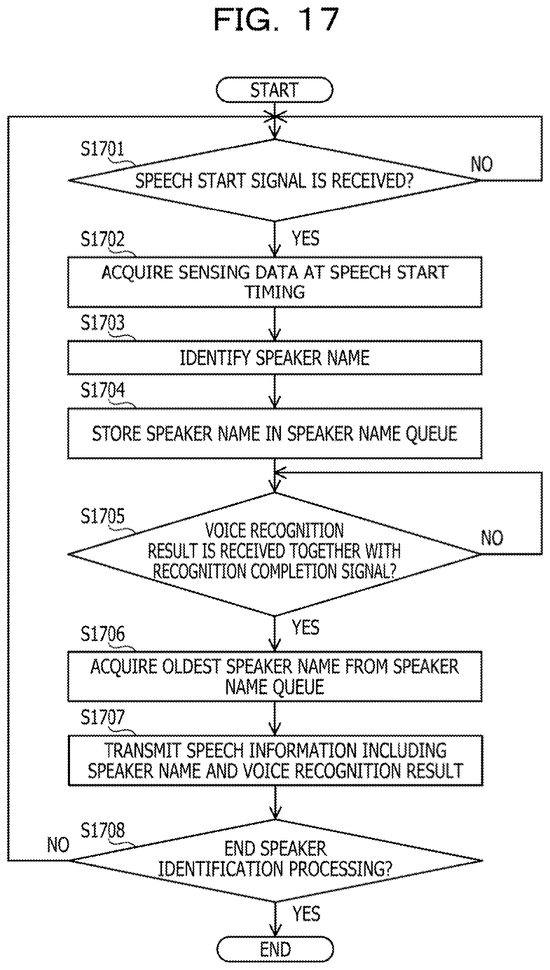

Next, a speaker identification processing procedure of the information processing apparatus 101 will be described with reference to FIG. 17

FIG. 17 is a flowchart illustrating an example of the speaker identification processing procedure of the information processing apparatus 101. In the flowchart of FIG. 17, first, the information processing apparatus 101 determines whether or not a speech start signal is received from the voice recognition server 202 (step S1701).

A speech start signal is information indicating that speech has started, and includes information that identifies a speech start timing, for example. A speech start timing corresponds to a time point when input of first buffer data (voice data) is accepted by the microphone mc in the information processing apparatus 101. First buffer data is the first buffer data in a series of buffer data that forms one speech (speech section).

For example, when the voice recognition server 202 receives the first buffer data from the information processing apparatus 101, it transmits a speech start signal to the information processing apparatus 101. Then, the voice recognition server 202 sequentially processes the buffer data received from the information processing apparatus 101 to perform voice recognition processing of voice data. Additionally, when the voice recognition processing of one speech (speech section) is completed, the voice recognition server 202 transmits the voice recognition result together with a recognition completion signal to the information processing apparatus 101. A recognition completion signal indicates that voice recognition processing of one speech (speech section) is completed.

Here, the information processing apparatus 101 waits for reception of a speech start signal from the voice recognition server 202 (step S1701: No). Then, if the speech start signal is received (step S1701: Yes), the information processing apparatus 101 refers to the sensing data table 230 and acquires the sensing data at the speech start timing (step S1702). The speech start timing is identified from the speech start signal.

Next, the information processing apparatus 101 refers to the speaker correspondence table 220 (speaker correspondence table (tilt determination) 220a or speaker correspondence table (azimuth determination) 220b) to identify the speaker name on the basis of the acquired sensing data (step S1703). The speaker name is identified by a determination method selected from the first determination method using the motion sensor s1 and the second determination method using the geomagnetic sensor s2, for example.

Then, the information processing apparatus 101 stores the identified speaker name in a speaker name queue (step S1704). A speaker name queue is a queue having a first in first out (FIFO) structure. Next, the information processing apparatus 101 determines whether or not the voice recognition result is received together with the recognition completion signal from the voice recognition server 202 (step S1705). Here, the information processing apparatus 101 waits for reception of the voice recognition result together with the recognition completion signal from the voice recognition server 202 (step S1705: No).

Then, if the voice recognition result together with the recognition completion signal is received (step S1705: Yes), the information processing apparatus 101 acquires the oldest speaker name from the speaker name queue (step S1706). Next, the information processing apparatus 101 transmits the speech information including the acquired speaker name and the received voice recognition result to the minutes server 201 (step S1707).

Then, the information processing apparatus 101 determines whether or not to end the speaker identification processing (step S1708). Here, if the speaker identification processing is not ended (step S1708: No), the information processing apparatus 101 returns to step S1701. On the other hand, if the speaker identification processing is ended (step S1708: Yes), the information processing apparatus 101 ends the series of processes according to this flowchart.

As a result, it is possible to identify the speaker corresponding to voice data acquired by the microphone mc according to the measurement value of each of the sensors s1 and s2 at the timing when the voice data is input, and register speech information (speaker name, voice recognition result) in the minutes server 201.

Note that in step S1707, the information processing apparatus 101 may display the acquired speaker name in association with the received voice recognition result on the main screen (see FIG. 4, for example) or the conversation screen (see FIG. 14, for example).

As described above, according to the information processing apparatus 101 of the embodiment, for voice data acquired by the microphone mc provided in the information processing apparatus 101, the measurement value of the motion sensor s1 or the geomagnetic sensor s2 of the information processing apparatus 101 at the timing when input of the voice data is accepted can be identified. Then, according to the information processing apparatus 101, it is possible to determine switching of the speaker corresponding to the voice data, on the basis of the identified measurement value of the motion sensor s1 or the geomagnetic sensor s2.

As a result, it is possible to determine switching of the speaker corresponding to the voice data acquired by the microphone mc, by using the motion sensor s1 or the geomagnetic sensor s2 built in the information processing apparatus 101. For example, it is possible to determine switching of the speaker according to the posture of the information processing apparatus 101 that the user uses or the orientation of the information processing apparatus 101 that the user uses. For this reason, it is possible to identify the timing and part where the speaker has switched, and differentiate the voice data for each speaker.

Additionally, according to the information processing apparatus 101, it is possible to identify the speaker corresponding to the range including the identified measurement value of the motion sensor s1 or the geomagnetic sensor s2 by referring to the storage unit 810 (e.g., speaker correspondence table 220) that stores the range related to the measurement value of the motion sensor s1 or the geomagnetic sensor s2 in association with information for identifying the speaker.

As a result, the speaker corresponding to the voice data acquired by the microphone mc can be identified by using the motion sensor s1 or the geomagnetic sensor s2 built in the information processing apparatus 101. For example, it is possible to identify the speaker according to the posture of the information processing apparatus 101 that the user uses or the orientation of the information processing apparatus 101 that the user uses.

Additionally, according to the information processing apparatus 101, it is possible to output the recognition result obtained by performing voice recognition processing on voice data in association with the identified speaker.

As a result, it is possible to display the speech content (text data) obtained by performing voice recognition processing on voice data or record the speech content in the minutes DB 240 or the like, in association with the speaker.

Additionally, according to the information processing apparatus 101, it is possible to accept input of voice data by the unidirectional microphone mc.

This can improve the recording quality when the user points the microphone mc provided in the information processing apparatus 101 at the speaker.

Additionally, according to the information processing apparatus 101, it is possible to accept designation of a speaker corresponding to a range related to the measurement value of the motion sensor s1 or the geomagnetic sensor s2, and store information for identifying the designated speaker in the storage unit 810 in association with the range.

As a result, the speaker corresponding to the range related to the measurement value of the motion sensor s1 or the geomagnetic sensor s2 can be arbitrarily set. For example, when participants of an interview or a conference are decided, names (speaker names) of the participants can be set in association with ranges related to the measurement values of the sensors s1 and s2 while considering the relative positional relationship among the participants.

Additionally, according to the information processing apparatus 101, it is possible to accept selection of any one of the first determination method using the motion sensor s1 and the second determination method using the geomagnetic sensor s2. Then, according to the information processing apparatus 101, the speaker corresponding to the range including the identified measurement value of the motion sensor s1 or the geomagnetic sensor s2 can be identified by referring to the storage unit 10 according to the selected determination method.

As a result, the user can arbitrarily select the determination method according to the use case. For example, when the seat order is not decided in advance and there is not much time for presetting, the first determination method that enables identification of the speaker according to the posture of the information processing apparatus 101 used is selected. Alternatively, when the seat order of the conference room or the like is predetermined and sufficient time can be spent for presetting, the second determination method that enables identification of the speaker according to the orientation of the information processing apparatus 101 used is selected.

As described above, according to the information processing apparatus 101, it is possible to identify the speaker with a simple configuration using a general-purpose computer such as a smartphone or a mobile phone. Additionally, real-time speaker identification can be achieved without installing hardware such as a high-performance GPU. Additionally, since a device such as a special microphone equipped with multiple directional microphones is not required, the information processing apparatus 101 is excellent in portability and can be carried at all times in case of sudden use.

Note that the information processing method described in the present embodiment may be implemented by executing a prepared program on a computer such as a personal computer or a workstation. This information processing program is recorded on a computer-readable recording medium such as a hard disk, a flexible disk, a compact disc (CD)-ROM, a digital versatile disk (DVD), or a universal serial bus (USB) memory, and is read from the recording medium to be executed by the computer. Additionally, this information processing program may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
identifying, for voice data acquired by a microphone provided in an information processing apparatus, a measurement value of a motion sensor or a geomagnetic sensor of the information processing apparatus at a timing when input of the voice data is accepted; and
determining switching of a speaker corresponding to the voice data based on the identified measurement value of the motion sensor or the geomagnetic sensor.

2. The non-transitory computer-readable storage medium according to claim 1, wherein
the determining process includes
identifying a speaker corresponding to a range including the identified measurement value of the motion sensor or the geomagnetic sensor by referring to a storage unit that stores the range related to the measurement value of the motion sensor or the geomagnetic sensor in association with information for identifying the speaker.

3. The non-transitory computer-readable storage medium according to claim 1, wherein the process comprising
outputting a recognition result obtained by performing voice recognition processing on the voice data.

4. The non-transitory computer-readable storage medium according to claim 1, wherein the microphone is a unidirectional microphone.

5. The non-transitory computer-readable storage medium according to claim 2, wherein the process comprising:
accepting designation of the speaker corresponding to the range related to the measurement value of the motion sensor or the geomagnetic sensor; and
storing information for identifying the designated speaker in association with the range, in the storage unit.

6. The non-transitory computer-readable storage medium according to claim 2, wherein the process comprising:
causing the computer to execute a process of accepting selection of any one of a determination method using the motion sensor and a determination method using the geomagnetic sensor,
wherein the determining process includes identifying the speaker corresponding to the range including the identified measurement value of the motion sensor or the geomagnetic sensor by referring to the storage unit according to the selected determination method.

7. An information processing method executed by a computer, the information processing method comprising:
identifying, for voice data acquired by a microphone, a measurement value of a motion sensor or a geomagnetic sensor of an information processing apparatus at a timing when input of the voice data is accepted; and
determining switching of a speaker corresponding to the voice data based on the identified measurement value of the motion sensor or the geomagnetic sensor.

8. An information processing apparatus, comprising:
a memory; and
a processor coupled to the memory and configured to:
identify, for voice data acquired'by a microphone, a measurement value of a motion sensor or a geomagnetic sensor of the information processing apparatus at a timing when input of the voice data is accepted, and
determine switching of a speaker corresponding to the voice data based on the identified measurement value of the motion sensor or the geomagnetic sensor.
